(19) United States
(12) Patent Application Publication
(10) Pub. No.: US 2012/0251967 A1
(43) Pub. Date: Oct. 4, 2012

(54) LOADING UNIT AND PROCESSING SYSTEM

(75) Inventor: Hiroyuki MATSUURA, Oshu-shi (JP)

(73) Assignee: TOKYO ELECTRON LIMITED, Tokyo (JP)

(21) Appl. No.: 13/408,514

(22) Filed: Feb. 29, 2012

(30) Foreign Application Priority Data
Mar. 29, 2011 (JP) 2011-071285

(51) Int. Cl. F27D 1/00; B65G 25/00

(52) U.S. Cl. 432/247; 414/586

(57) ABSTRACT

A loading unit is provided under a processing unit for performing a thermal treatment process on a substrate, loads/unloads a substrate holding mechanism by which substrates are held to the processing unit, and transfers the substrates to the substrate holding mechanism. The loading unit includes a loading case provided to be connected to the processing unit and surrounds the entire processing unit; an elevator mechanism that has a holding arm for holding a lower portion of the substrate holding mechanism and moves up/down the substrate holding mechanism; a substrate transfer mechanism which transfers the substrates to the substrate holding mechanism; and a substrate holding mechanism accommodating recess portion provided in a lower portion of the loading case corresponding to the lower portion of the substrate holding mechanism and is provided to protrude downward to accommodate a lower end portion of the substrate holding mechanism.

### CROSS-REFERENCE TO RELATED PATENT APPLICATIONS

This application claims the benefit of Japanese Patent Application No. 2011-071285, filed on Mar. 29, 2011 in the Japan Patent Office, the disclosure of which is incorporated herein in its entirety by reference.

### BACKGROUND OF THE INVENTION

1. Field of the Invention

The present invention relates to a processing system for performing a thermal treatment process on a substrate such as a semiconductor wafer and a loading unit used in the processing system.

2. Description of the Related Art

In general, in order to manufacture a semiconductor integrated circuit such as an integrated circuit (IC) or a large-scale integration (LSI), various thermal treatment processes, for example, a film-forming process, an oxidation diffusion process, an etching process, an annealing process, etc., are performed on a substrate such as a semiconductor wafer. In order to process a plurality of substrates at a time, a vertical batch-type thermal treatment apparatus is used, for example, as described in Patent References 1 and 2.

In such a thermal treatment process apparatus, a wafer boat on which substrates constituted of a plurality of semiconductor wafers, e.g., about 100 to 150 semiconductor wafers, are placed is moved up from a loading chamber which is located below a vertical processing container formed of quartz and which has a dry air atmosphere where a dew point and an oxygen concentration are controlled or an inert gas atmosphere and is loaded (inserted) into the vertical processing container, and then a thermal treatment process such as a film-forming process is performed in the processing container that is sealed. Then, after the thermal treatment process is performed, the wafer boat is unloaded (moved down) and transferred to interchange the already processed substrates with semiconductor wafers that have not been processed. Then, the above-described thermal treatment process is repeated.

In order to move up the wafer boat, a boat elevator provided in the loading chamber is used, and also the substrate is transferred by a transfer mechanism provided in the loading chamber.

Recently, in order to further increase a production efficiency of a semiconductor integrated circuit, it is expected that a diameter of a substrate is to be further enlarged. For example, it is required that a diameter of a substrate be enlarged from about 300 mm to about 450 mm. As such, if a diameter of substrates is enlarged, when the substrates are placed on a wafer boat, each pitch between the substrates needs to be increased in order to sufficiently flow a processing gas between the substrates. For example, it is required that each pitch between substrates having a diameter of about 300 mm be in a range of about 6 to about 8 mm, while each pitch between substrates having a diameter of about 450 mm be in a range of about 8 to about 12 mm.

In this case, a number of substrates that may be processed at a time is required to be the same as a number of substrates used in a conventional batch-type thermal treatment apparatus, e.g., about 100 to 150 substrates, to increase a production efficiency, and thus a height of a processing container, a length of a wafer boat, and a length of a stroke for moving up the wafer boat are increased as much as the increase of each pitch between the substrates. Consequently, a height of a processing system including a processing unit that includes a processing container and a loading unit that includes a loading chamber provided under the processing unit is increased, and thus the entire height of the processing system is in a range of about 4000 to about 5000 mm. As such, if a height of a processing system is increased, the processing system may not be provided in a clean room of an existing building.

### PRIOR ART REFERENCE

(Patent Reference 1) Japanese Patent Laid-Open Publication No. 2001-093851

(Patent Reference 2) Japanese Patent Laid-Open Publication No. 2002-076089

### SUMMARY OF THE INVENTION

The present invention is made in view of the above-described problem to effectively resolve the problem. The prevent invention provides a loading unit and a processing system that allow a lower end portion of a substrate holding mechanism such as a wafer boat to be accommodated in a recess portion provided at a bottom surface on which the processing system is provided and thus may suppress an actual height of the loading unit.

According to an aspect of the present invention, a loading unit that is provided under a processing unit for performing a thermal treatment process on a substrate, loads/unloads a substrate holding mechanism by which a plurality of substrates are held to the processing unit, and transfers the substrates to the substrate holding mechanism, the loading unit including: a loading case that is provided to be connected to the processing unit and surrounds the entire processing unit; an elevator mechanism that has a holding arm for holding a lower portion of the substrate holding mechanism and moves up/down the substrate holding mechanism to an interior of the processing unit; a substrate transfer mechanism that transfers the substrates to the substrate holding mechanism; and a substrate holding mechanism accommodating recess portion that is provided in a lower portion of the loading case corresponding to the lower portion of the substrate holding mechanism and is provided to protrude downward to accommodate a lower end portion of the substrate holding mechanism.

As such, the substrate holding mechanism accommodating recess portion is provided to protrude downward in the lower portion of the loading case of the loading unit provided in a bottom surface, so that the substrate holding mechanism accommodating recess portion may be accommodated in the recess portion provided in the bottom surface and the lower end portion of the substrate holding mechanism may be accommodated in the substrate holding mechanism accommodating recess portion, thereby suppressing a height of the loading unit from the bottom surface, that is, an actual height of the loading unit.

According to another aspect of the present invention, a processing system including: a processing unit that performs a thermal treatment process on a substrate; the loading unit provided under the processing unit; and a stocker unit that is provided parallel to the loading unit and in which a substrate container accommodating a plurality of substrates stands by.

Additional objects and advantages of the invention will be set forth in the description which follows, and in part will be obvious from the description, or may be learned by practice of the invention.

The objects and advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a cross-sectional view of a processing system including a loading unit according to an embodiment of the present invention;

FIG. 2 is a cross-sectional view of a processing system when a substrate holding mechanism is loaded (inserted) into a processing container;

FIG. 3 is a partial cross-sectional view showing a first modified embodiment of the loading unit according to the present invention;

FIG. 4 is a partial cross-sectional view showing a second modified embodiment of the loading unit according to the present invention; and

FIGS. 5A and 5B are partial cross-sectional views showing a third modified embodiment of the loading unit according to the present invention.

### DETAILED DESCRIPTION OF THE INVENTION

An embodiment of the present invention achieved on the basis of the findings given above will now be described with reference to the accompanying drawings. In the following description, the constituent elements having substantially the same function and arrangement are denoted by the same reference numerals, and a repetitive description will be made only when necessary.

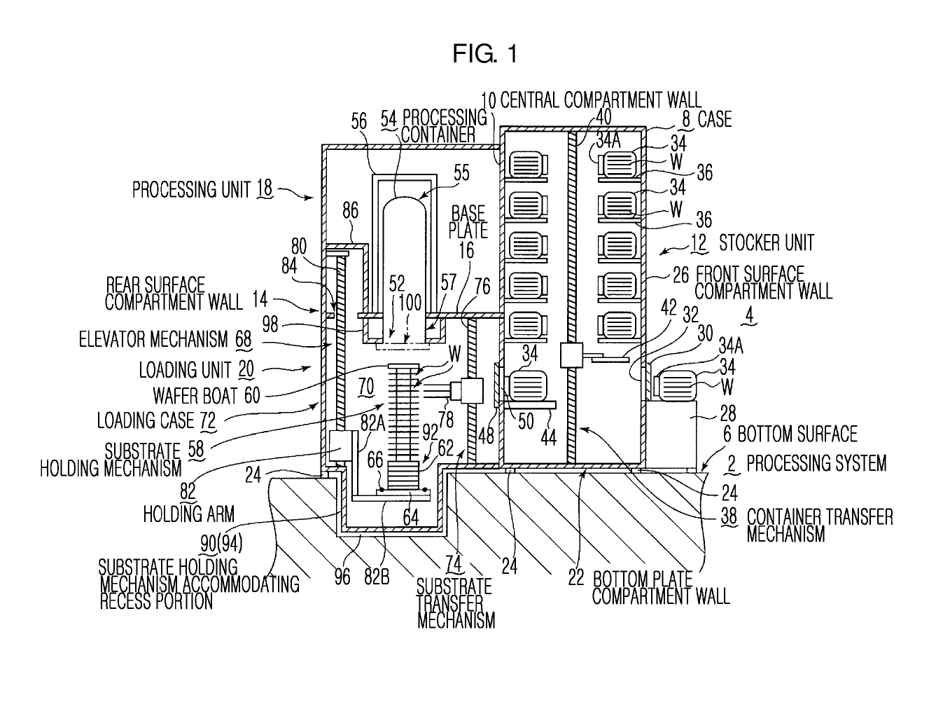

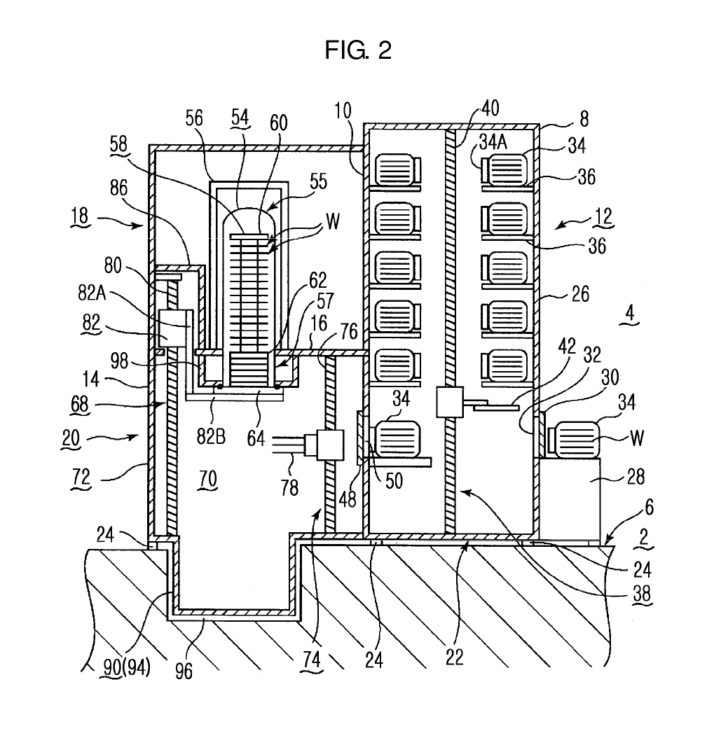

Hereinafter, exemplary embodiments of a loading unit and a processing system will be described with reference to the accompanying drawings. FIG. 1 is a cross-sectional view of the processing system including the loading unit according to an embodiment of the present invention. FIG. 2 is a cross-sectional view of the processing system when a substrate holding mechanism is loaded (inserted) into a processing container.

Referring to FIGS. 1 and 2, the processing system 2 is provided on a bottom surface 6 in a clean room 4 in which a down flow of clean air is formed. An exterior of the processing system 2 is defined by a large case 8 formed of, for example, stainless steel.

A central compartment wall 10 formed of, for example, stainless steel, is provided in a heightwise direction in the case 8. An interior of the case 8 is divided into right and left sides and a front portion (a right side when seen from FIG. 1) of the case 8 is provided as a stocker unit 12. Also, a base plate 16 is provided in a horizontal direction as a compartment wall formed of, e.g., stainless steel, between the central compartment wall 10 and a rear side compartment wall 14 provided in a rear portion of the case 8. An interior between the central compartment wall 10 and a rear side compartment wall 14 is divided into upper and lower sides and a processing unit 18 is provided at the upper side, and a loading unit 20 is provided at the lower side. Accordingly, the stocker unit 12 described above and the loading unit 20 are provided in parallel.

In addition, the entire weight of the processing system 2 is supported by a bottom plate compartment wall 22 for dividing a lower portion of the case 8. In detail, a plurality of supporting protrusions 24 having an adjustable height are provided on a lower surface of the bottom plate compartment wall 22. The supporting protrusions 24 are in contact with the bottom surface 6 so that the entire weight of the processing system 2 may be supported and a horizontal state of the processing system 2 may be maintained.

An inlet/outlet port 28 on which a substrate container 34 accommodating a plurality of substrates W constituted of, e.g., semiconductor wafers, is placed is provided on a lower portion of a front side compartment wall 26 of the stocker unit 12. A cover 34A that is openable and closable is attached to a front surface of the substrate container 34. Also, an inlet/outlet 32 that is opened and closed by an opening/closing door 30 is provided in the front side compartment wall 26 corresponding to the inlet/outlet port 28 so as to carry the substrate container 34 into/out the stocker unit 12.

The substrate container 34 may be configured as a cassette or a sealed container referred to as FOUP (a registered trademark) that may accommodate the substrates W, for example, about 25 substrates W. In this regard, the sealed container is used, and an inert gas, e.g., an N₂ gas, is sealed in the sealed container to prevent the substrates W from being oxidized.

A plurality of stock shelves 36 are provided along a vertical direction in the stocker unit 12, and the substrate container 34 accommodating the substrates W that have not been processed or the substrates W that have already been processed is placed on the stock shelves 36 and then stands by. A container transfer mechanism 38 is provided in the stocker unit 12. In detail, the container transfer mechanism 38 includes a guide rail 40 that is perpendicularly provided and includes, e.g., ball threads, and a container transfer arm 42 that moves up/down along the guide rail 40. The container transfer arm 42 is freely bent in a horizontal direction and is provided to horizontally rotate so as to transfer the substrate container 34 between the inlet/outlet port 28 and the stock shelves 36.

Also, a container transfer port 44 attached to the central compartment wall 10 is provided in the stocker unit 12 so that the substrate container 34 may be placed on the container transfer port 44. The substrate container 34 between the container transfer port 44 and the stock shelves 36 or the inlet/outlet port 28 is transferred by using the container transfer mechanism 38.

In addition, a substrate inlet/outlet 50 that is opened and closed by an opening/closing door 48 is provided in the central compartment wall 10 to which the container transfer port 44 is attached, and the substrate W may be carried into/out the loading unit 20 through the substrate inlet/outlet 50 between the container transfer port 44 and the loading unit 20. Also, a down flow of clean air is provided in the stocker unit 12.

Furthermore, a processing container 54 having an opening 52 by which a lower end portion of the processing container 54 is opened and having a circular shape is provided in the processing unit 18. The processing container 54 includes a container body 55 formed of, e.g., quartz, having heat-resistant and corrosion-resistant properties, and a manifold 57 that is provided at a lower end portion of the container body 55 and is formed of, e.g., stainless steel. A lower end of the manifold 57 is the opening 52. A lower portion of the processing container 54 is supported by the base plate 16, and the base plate 16 supports the weight of the processing container 54.

A heater 56 that has a tubular shape is provided on an outer circumferential side of the processing container 54 in a concentric shape so as to heat the substrates accommodated in the processing container 54. Also, a gas supply system (not shown) for supplying various gases necessary for a thermal treatment process or an exhaust system (not shown) for evacuating an atmosphere in the processing container 54 while controlling pressure is provided on a lateral wall of the manifold 57 of the processing container 54. Also, a substrate holding mechanism 58 that holds the substrates W in a multistage manner may be accommodated in the processing container 54.

The substrate holding mechanism 58 includes a wafer boat 60 that is formed of quartz and supports the substrates W in a multistage manner at a predetermined pitch and a heat reserving tank 62 that is formed of quartz, is provided under the wafer boat 60 to support the wafer boat 60, and maintains a temperature of the substrates W. The heat reserving tank 62 is supported rotatably or fixedly by a cap 64 that closes the opening 52 of the processing container 54 and is formed of, e.g., stainless steel. Also, a sealing member 66 (see FIG. 2) formed as, e.g., an O-ring, is interposed between a peripheral portion of the cap 64 and the lower end portion of the processing container 54 to hermetically seal an inside of the processing container 54. The substrate holding mechanism 58 is moved up/down by an elevator mechanism 68 provided in the loading unit 20.

Here, a loading case 72 constitutes an exterior of the loading unit 20, and a loading chamber 70 that is hermetically sealed constitutes an interior of the loading case 72. Accordingly, the loading chamber 70 is defined by the base plate 16, a lower portion of the rear side compartment wall 14, a lower portion of the central compartment wall 10, and a left portion of the bottom plate compartment wall 22, which constitute the loading case 72 as shown in FIG. 1.

As such, the loading case 72 is provided to be connected to a lower portion of the processing unit 18. Also, the base plate 16 also functions as a compartment wall used to define the processing unit 18, and the central compartment wall 10 also functions as a compartment wall used to define the stocker unit 12.

A substrate transfer mechanism 74 for transferring the substrates W to the wafer boat 60 of the substrate holding mechanism 58 is provided between a portion just below the processing container 54 and the container transfer port 44 of the stocker unit 12. In detail, the substrate transfer mechanism 74 includes a guide rail 76 that is perpendicularly provided and includes, e.g., ball threads, and a transfer arm 78 that moves up/down along the guide rail 76. An upper end of the guide rail 76 is supported by and fixed to the base plate 16, and a lower end thereof is supported by and fixed to the bottom plate compartment wall 22. Also, there are a plurality of the transfer arms 78, and the transfer arms 78 are swivable and bendable/stretchable within a horizontal plane, and thus the transfer arms 78 may transfer a plurality of the substrates W at a time between the wafer boat 60 and the substrate container 34 provided on the container transfer port 44.

The elevator mechanism 68 for moving up/down the substrate holding mechanism 58 includes a guide rail 80 that is perpendicularly provided and includes, e.g., ball threads, and a holding arm 82 that moves up/down along the guide rail 80. Here, in order to increase an upward stroke amount of the holding arm 82, a through hole 84 is provided in the base plate 16, and an upper portion of the guide rail 80 is inserted into and passes through the through hole 84 to extend the guide rail 80 to the processing unit 18. Also, an upper end of the guide rail 80 is fixed to the rear side compartment wall 14. The portion of the guide rail 80 extended to the processing unit 18 is hermetically surrounded by a dividing compartment wall 86, and a lower portion of the compartment wall 86 is connected to the base plate 16 to maintain a hermetic seal inside the loading chamber 70.

The holding arm 82 is extended downward to support a lower end portion of the substrate holding mechanism 58 accommodated in a substrate holding mechanism accommodating recess portion 90, which will be described later. In detail, the holding arm 82 includes a vertical portion 82A extended downward and a horizontal portion 82B extended in a horizontal direction from a lower end of the vertical portion 82A, and the entire holding arm 82 is formed into a L-shape. The horizontal portion 82B supports the lower portion of the substrate holding mechanism 58 to hold the substrate holding mechanism 58.

As a feature of the present invention, the substrate holding mechanism accommodating recess portion 90 is provided at a lower portion of the loading case 72 corresponding to a lower side of the substrate holding mechanism 58, and the substrate holding mechanism accommodating recess portion 90 is protruded downward to accommodate the lower end portion of the substrate holding mechanism 58. In detail, the substrate holding mechanism accommodating recess portion 90 includes an opening 92 that is provided in the bottom plate compartment wall 22 and a recess portion compartment wall 94 that is extended downward to have a bottom and is connected to a peripheral portion of the opening 92. The recess portion compartment wall 94 is formed of a metal, for example, stainless steel, and an upper end of the recess portion compartment wall 94 is connected to the bottom plate compartment wall 22. As described above, the lower end portion of the substrate holding mechanism 58 may be accommodated in the substrate holding mechanism accommodating recess portion 90.

In order to provide the substrate holding mechanism accommodating recess portion 90, a hole 96 having a recess shape is provided by removing a portion of the bottom surface 6 corresponding to a portion of the substrate holding mechanism accommodating recess portion 90 to be provided within the clean room 4. In other words, the processing system 2 is provided in a state where the substrate holding mechanism accommodating recess portion 90 is accommodated in the hole 96. Accordingly, the lower end portion of the substrate holding mechanism 58 may be moved downward from the bottom plate compartment wall 22, and thus a height of the processing system 2 from the bottom surface 6 may be suppressed.

In this case, in order for the substrates W to be transferred to the wafer boat 60 by the transfer arm 78, the heat reserving tank 62 may be accommodated in the substrate holding mechanism accommodating recess portion 90 so that a lower end portion of the wafer boat 60 of the substrate holding mechanism 58 is positioned over the bottom plate compartment wall 22, and thus even when the transfer arm 78 is positioned at a lowermost stroke end, the transfer arm 78 may access a lowermost end of the wafer boat 60 to transfer the substrates W.

Also, during unloading of the wafer boat 60, when a space is provided between an upper end of the wafer boat 60 and the base plate 16, the substrates W may be transferred while moving up the wafer boat 60, and thus the substrate holding mechanism accommodating recess portion 90 may be deeply provided so as to accommodate the lower end portion of the wafer boat 60 as well as the heat reserving tank 62 in the substrate holding mechanism accommodating recess portion 90.

Consequently, during unloading of the wafer boat 60, the height of the processing system 2 from the bottom surface 6 may be set low by a height of the substrate holding mechanism 58 that may be accommodated in the substrate holding mechanism accommodating recess portion 90.

Also, a scavenger box 98 of which a lower central portion is opened as the opening 52 is provided in the loading chamber 70 at an outer circumference of a lower end portion of the processing container 54, and a shutter 100 is provided in the opening 52. The shutter 100, which is openable and closable, is provided to be closed when the substrate holding mechanism 58 is unloaded downward. An exhaust path (not shown) for evacuating an inner atmosphere is connected to the scavenger box 98 to prevent exhaust heat in the processing container 54 from being flowed into the loading chamber 70.

A cross-flow of an inert gas, e.g., an N₂ gas, is formed in the loading chamber 70 from a wall surface of one side of the loading chamber 70 to a wall surface of another side thereof facing the one side to prevent the substrates W constituted of semiconductor wafers from being naturally oxidized. The overall manipulation of the processing system 2 constituted in this manner is controlled by a system controller constituted of, for example, a computer (not shown). Also, the loading chamber 70 may have a dry air atmosphere where a dew point and an oxygen concentration are controlled.

Next, a manipulation of the processing system having the above-described configuration will be described. First, the overall process of the processing system will be described. A plurality of the substrates W that have been processed in a previous process are provided on the inlet/outlet port 28 at a front side of the processing system 2 in a state where the substrates W are accommodated in the substrate container 34 filled with an atmosphere of a nitrogen gas as an inert gas. After opening the opening/closing door 30 of the inlet/outlet port 28, the substrate container 34 provided in the inlet/outlet port 28 is held by the container transfer arm 42 of the container transfer mechanism 38 and is carried into the stocker unit 12.

The carried substrate container 34 is temporarily placed on the stock shelves 36 and then stands by. Then, when it is time to be processed, the substrate container 34 is placed on the container transfer port 44 provided in the central compartment wall 10 by using the container transfer mechanism 38 again. If the substrate container 34 is placed on the container transfer port 44, the opening/closing door 48, which is provided on a side of the substrate inlet/outlet 50 opposite to a side at which the container transfer port 44 is located in the central compartment wall 10, is opened.

In this instance, the cover 34A of the substrate container 34 is simultaneously removed by a cover opening/closing mechanism (not shown) provided in the substrate inlet/outlet 50 to open an inside of the substrate container 34. In this case, in a state where the substrate container 34 placed on the container transfer port 44 is hermetically pressed against a peripheral edge of the substrate inlet/outlet 50 by using an actuator (not shown), the cover 34A of the substrate container 34 is opened at the same time that the opening/closing door 48 inside the loading chamber 70 is opened.

Then, by using the transfer arm 78 of the substrate transfer mechanism 74 in the loading chamber 70, all the substrates W in the substrate container 34 are transferred onto the wafer boat 60 of the unloaded substrate holding mechanism 58. In this instance, the lower end portion of the substrate holding mechanism 58 is accommodated in the substrate holding mechanism accommodating recess portion 90 in a state where the lower end portion of the substrate holding mechanism 58 is supported by the holding arm 82 of the elevator mechanism 68 as shown in FIG. 1. Then, by repeating the above-described manipulation, all the substrates W in a plurality of substrate containers 34 are transferred onto the wafer boat 60, and thus the wafer boat 60 enters a full loading state. In this instance, the transfer arm 78 moves up/down in a heightwise direction of the wafer boat 60 to transfer the substrates W.

As described above, if the wafer boat 60 is fully loaded with the substrates W, the holding arm 82 is moved up by driving the elevator mechanism 68, and the wafer boat 60 is inserted into the processing container 54 of the processing unit 18 from a lower side of the processing container 54 to load the substrates W into the processing container 54 as shown in FIG. 2. In this instance, the opening 52 provided at the lower end of the processing container 54 is sealed by the cap 64.

As such, if the processing container 54 is sealed, a predetermined thermal treatment process, for example, a film-forming process, is performed by increasing temperatures of the substrates W loaded into the processing container 54 to a process temperature by using the heater 56 provided on the outer circumferential side of the processing container 54 and introducing a predetermined processing gas into the processing container 54 to maintain a predetermined pressure in the processing container 54.

In this way, if a predetermined thermal treatment process is finished, the processed substrates W are carried out by performing a manipulation opposite to the above-described manipulation. First, the holding arm 82 is moved down by driving the elevator mechanism 68 so that the substrate holding mechanism 58 including the wafer boat 60 is carried out downward from the processing container 54, thereby unloading the substrates W. When the unloading of the substrates W has ended, the lower end portion of the substrate holding mechanism 58 is accommodated in the substrate holding mechanism accommodating recess portion 90 in a state where the lower end portion of the substrate holding mechanism 58 is held by the holding arm 82 as shown in FIG. 1.

In this instance, a cross-flow of an N₂ gas as a cooling gas is formed in the loading chamber 70 to cool the substrates W to a predetermined temperature. Also, the opening 52 of the scavenger box 98 provided at the lower end portion of the processing container 54 is closed by the shutter 100 to prevent exhaust heat from being flowed into and entering the loading chamber 70.

The substrates W cooled to the predetermined temperature are carried out along a path opposite to the above-described path for transferring the substrates W. In other words, the processed substrates W of the wafer boat 60 are carried out by the transfer arm 78 of the substrate transfer mechanism 74, and then are accommodated in the substrate container 34 that is empty and is placed on the container transfer port 44. Then, the substrate container 34 including the processed substrates W is carried out the inlet/outlet port 28 after being temporarily stored on the stock shelves 36 or directly, by using the container transfer arm 42 of the container transfer mechanism 38.

As described above, in the present invention, a portion of the bottom plate compartment wall 22, which defines the lower portion of the loading chamber 70, corresponding to the lower side of the processing container 54, that is, the lower side of the substrate holding mechanism 58, is recessed to have a recess shape, and the substrate holding mechanism accommodating recess portion 90 is provided in a recess portion of the bottom plate compartment wall 22. The lower end portion of the substrate holding mechanism 58 during unloading of the substrates W is accommodated in the substrate holding mechanism accommodating recess portion 90. Accordingly, the height of the processing system 2 from the bottom surface 6 may be decreased by a length of the substrate holding mechanism 58 accommodated in the substrate holding mechanism accommodating recess portion 90. In other words, an actual height of the loading unit 20 (a height of the loading unit 20 from the bottom surface 6) may be suppressed by the length of the substrate holding mechanism 58.

Thus, as in the case of 450 mm-size substrates, even in a case where the entire height of a processing system is increased because each pitch between the substrates is greater than that in the case of 300 nm-size substrates, the processing system for 450 mm-size substrates may be provided in a clean room based on a SEMI standard of an existing building restricting a height inside a clean room, by providing the substrate holding mechanism accommodating recess portion 90 in the processing system as described above.

As described above, in the present invention, the substrate holding mechanism accommodating recess portion 90 is provided to protrude downward, in the lower portion of the loading case 72 of the loading unit provided on the bottom surface 6 so that the substrate holding mechanism accommodating recess portion 90 may be accommodated in the hole 96 provided in the bottom surface, for example, and that a lower end portion of a substrate holding mechanism may be accommodated in the substrate holding mechanism accommodating recess portion 90, thereby suppressing the height of the loading unit 20 from the bottom surface 6, which is the actual height of the loading unit 20.

### First Modified Embodiment

Next, a first modified embodiment of the loading unit according to the present invention will be described. In the loading unit described above with reference to FIGS. 1 and 2, the holding arm 82 of the elevator mechanism 68 is provided into an L-shape by including the vertical portion 82A extended vertically downward and the horizontal portion 82B extended in a horizontal direction from the vertical portion 82A. However, the present invention is not limited thereto.

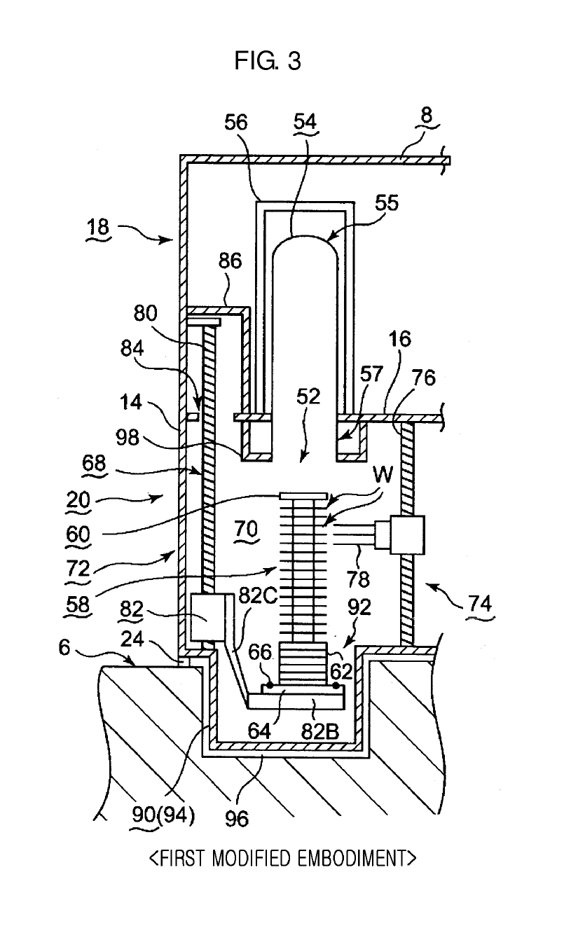

For example, as shown in FIG. 3 showing a partial cross-sectional view of a loading unit according to the first modified embodiment, an inclined portion 82C that is extended obliquely and downwardly toward a lower central portion of the substrate holding mechanism accommodating recess portion 90 may be used instead of the vertical portion 82A. Also, in FIG. 3, the same reference numerals as in FIGS. 1 and 2 denote the same components. The first modified embodiment may produce the same functions and effects as the embodiment described above with reference to FIGS. 1 and 2.

### Second Modified Embodiment

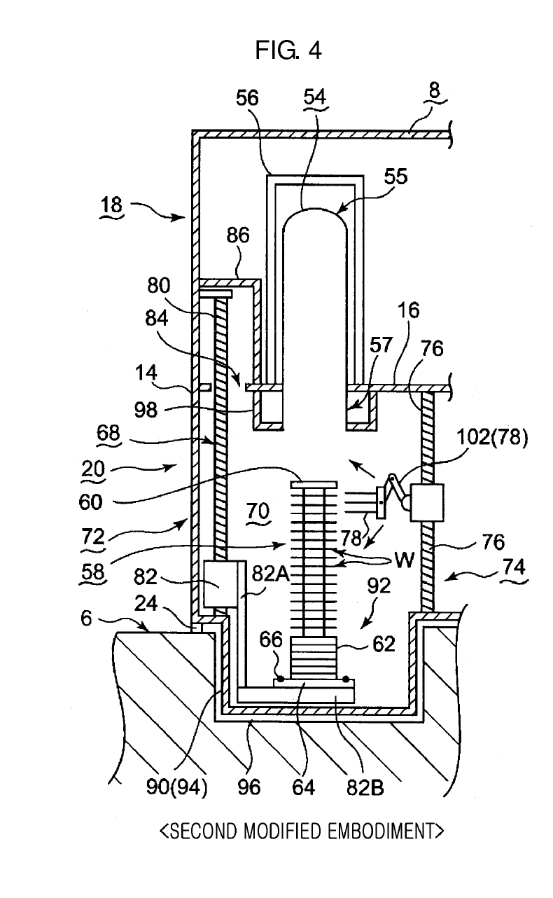

Next, a second modified embodiment of the loading unit according to the present invention will be described. In the above-described loading units, the transfer arm 78 of the substrate transfer mechanism 74 is swivable and bendable/stretchable within a horizontal plane. However, the present invention is not limited thereto, and the transfer arm 78 may employ a transfer mechanism that may bend and stretch in a vertical direction, that is, up and down. FIG. 4 is a partial cross-sectional view showing a loading unit according to the second modified embodiment of the present invention. In FIG. 4, the same reference numerals as in FIGS. 1 and 2 denote the same components.

As shown in FIG. 4, a multi-joint bending/stretching arm 102 that may swivel within a horizontal plane and also obliquely bend/stretch upward and downward and bend/stretch in a horizontal direction is used as the transfer arm 78 of the substrate transfer mechanism 74. Thus, the multi-joint bending/stretching arm 102 may move in a vertical direction along the guide rail 76 and transfer the substrates W in a vertical direction by a length of a stroke of the multi-joint bending/stretching arm 102 when stopped at one place.

Accordingly, for example, when the lower end portion of the wafer boat 60 is accommodated in the substrate holding mechanism accommodating recess portion 90, the transfer arm 78 may bend and stretch only in a horizontal direction in the substrate transfer mechanism 74 shown in FIGS. 1 and 2, and thus the substrates W may not be transferred to the wafer boat 60. However, in the second modified embodiment, as described above, since the multi-joint bending/stretching arm 102 itself may obliquely bend and stretch in a vertical direction, the substrates W may be also transferred to the lower end portion of the wafer boat 60, which is partially accommodated in the substrate holding mechanism accommodating recess portion 90, within a range of the stroke of the multi-joint bending/stretching arm 102.

In this case, since the multi-joint bending/stretching arm 102 is positioned at a lowermost end portion of the guide rail 76 and obliquely bends downward, a width of the substrate holding mechanism accommodating recess portion 90 may be set to be slightly large to prevent the multi-joint bending/stretching arm 102 from interfering with the recess portion compartment wall 94 during bending/stretching of the multi-joint bending/stretching arm 102.

In the second modified embodiment, a height of the processing system 2 from the bottom surface 6 may be further decreased by a length of the wafer boat 60 that may be accommodated in the substrate holding mechanism accommodating recess portion 90. Also, in the second modified embodiment, the holding arm 82 according to the first modified embodiment of FIG. 3 may be employed, obviously. The second modified embodiment may produce the same functions and effects as the above-described embodiments.

### Third Modified Embodiment

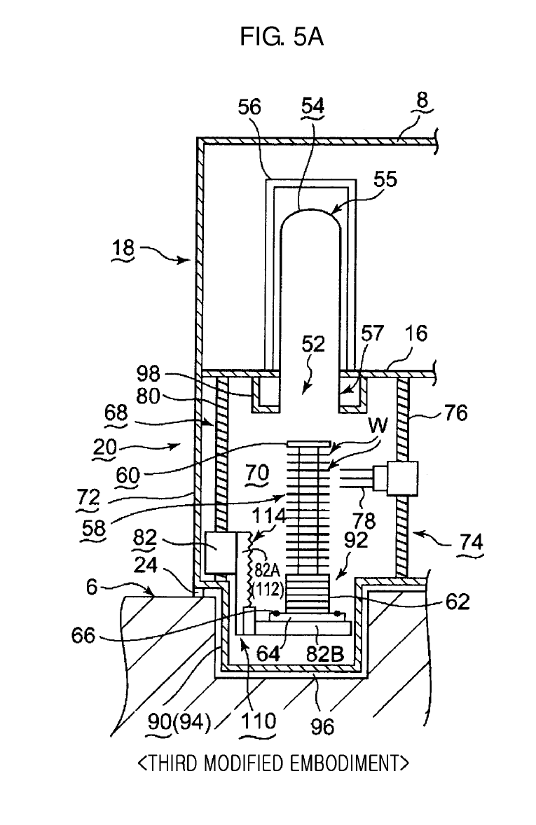

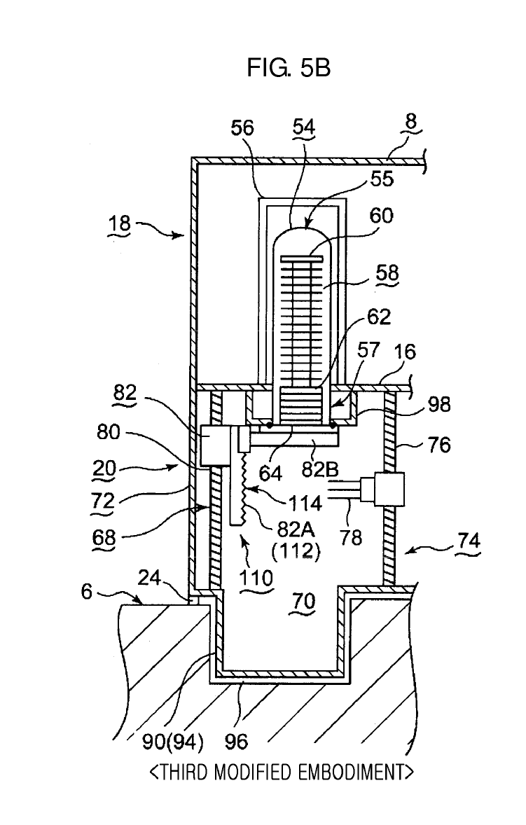

Next, a third modified embodiment of the loading unit 20 according to the present invention will be described. In the above-described loading units, the holding arm 82 of the elevator mechanism 68 includes the vertical portion 82A and the horizontal portion 82B (see FIG. 1) or includes the inclined portion 82C and the horizontal portion 82B (see FIG. 3). However, an elevator mechanism may be additionally provided in the holding arm 82. FIGS. 5A and 5B are partial cross-sectional views showing a loading unit according to the third modified embodiment of the present invention. FIG. 5A shows the loading unit when a wafer boat is unloaded, and FIG. 5B shows the loading unit when the wafer boat is loaded. In FIGS. 5A and 5B, the same reference numerals as in FIGS. 1 and 2 denote the same components

As shown in FIGS. 5A and 5B, an auxiliary elevator mechanism 110 that moves up/down while holding the substrate holding mechanism 58 is provided in the holding arm 82 of the elevator mechanism 68. In detail, the vertical portion 82A of the holding arm 82 is provided as an auxiliary guide rail 112, and a base end portion of the horizontal portion 82B is attached to the auxiliary guide rail 112 to move in a vertical direction.

Accordingly, the horizontal portion 82B may move up/down with a stroke corresponding to a length of the auxiliary guide rail 112. In FIGS. 5A and 5B, a rack 114 is provided in the auxiliary guide rail 112 to engage with a gear (not shown), thereby moving up the horizontal portion 82B. However, the present invention is not limited to this structure.

In this case, a sum of a length of the guide rail 80 of the elevator mechanism 68 and a length of the auxiliary guide rail 112 of the auxiliary elevator mechanism 110 is a stroke amount of the wafer boat 60. Thus, an upper end portion of the guide rail 80 of the elevator mechanism 68 does not need to be extended up to inside the processing unit 18, and the upper end portion of the guide rail 80 may be supported by and fixed to the base plate 16 or a lower side of the base plate 16 similar to a conventional loading chamber.

In other words, in the third modified embodiment, when the wafer boat 60 is loaded, in a state where the holding arm 82 is positioned at an upper end of the guide rail 80 as shown in FIG. 5B, the auxiliary elevator mechanism 110 is additionally driven to move up the horizontal portion 82B of the holding arm 82 up to an upper end of the auxiliary guide rail 112, thereby accommodating the wafer boat 60 in the processing container 54. The third modified embodiment may produce the same functions and effects as the above-described embodiments. Also, in the third modified embodiment, the substrate transfer mechanism 74 according to the second modified embodiment of FIG. 4 may be employed, obviously.

Also, in the present invention, although it has been exemplified that a semiconductor wafer is used as a substrate, the semiconductor wafer may include a silicon substrate or a compound semiconductor substrate formed of, for example, GaAs, SiC, or GaN, and the present invention is not limited to those substrates. The present invention may also be applied to a glass substrate, a ceramic substrate or the like used in a liquid crystal display apparatus. Also, although a processing container, a wafer boat, and a heat reserving tank that are formed of quartz have been exemplified in the above-described embodiments, the processing container, the wafer boat, and the heat reserving tank may be formed of silicon carbide (SiC) or polysilicon instead of quartz, and the present invention may be applied to a silicon-based wafer boat.

According to the loading unit and the processing system of the present invention, excellent functions and effects may be produced as follows.

A substrate holding mechanism accommodating recess portion is provided to protrude downward in a lower portion of a loading case of loading a loading unit that is provided on a bottom surface, so that the substrate holding mechanism accommodating recess portion may be accommodated in a recess portion provided in the bottom surface and a lower end portion of a substrate holding mechanism may be accommodated in the substrate holding mechanism accommodating recess portion, thereby suppressing a height of the loading unit from the bottom surface, that is, an actual height of the loading unit.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A loading unit that is provided under a processing unit for performing a thermal treatment process on a substrate, loads/unloads a substrate holding mechanism by which a plurality of substrates are held to the processing unit, and transfers the substrates to the substrate holding mechanism, the loading unit comprising:
a loading case which is provided to be connected to the processing unit and surrounds the entire processing unit;
an elevator mechanism which has a holding arm for holding a lower portion of the substrate holding mechanism and moves up/down the substrate holding mechanism to an interior of the processing unit;
a substrate transfer mechanism which transfers the substrates to the substrate holding mechanism; and
a substrate holding mechanism accommodating recess portion which is provided in a lower portion of the loading case corresponding to the lower portion of the substrate holding mechanism and is provided to protrude downward to accommodate a lower end portion of the substrate holding mechanism.

2. The loading unit of claim 1, wherein the holding arm of the elevator mechanism is extended downward to support the lower end portion of the substrate holding mechanism accommodated in the substrate holding mechanism accommodating recess portion.

3. The loading unit of claim 1, wherein an auxiliary elevator mechanism that moves up/down while holding the substrate holding mechanism is provided in the holding arm of the elevator mechanism.

4. The loading unit of claim 1, wherein the substrate transfer mechanism comprises a transfer arm that is movable in a vertical direction to transfer the substrates to the substrate holding mechanism.

5. The loading unit of claim 4, wherein the transfer arm obliquely bends and stretches upward and downward and bends and stretches in a horizontal direction.

6. A processing system comprising:
a processing unit which performs a thermal treatment process on a substrate;
the loading unit of claim 1 provided under the processing unit; and
a stocker unit which is provided parallel to the loading unit and in which a substrate container accommodating a plurality of substrates stands by.
